(19) United States
(12) Patent Application Publication
(10) Pub. No.: US 2024/0289180 A1
(43) Pub. Date: Aug. 29, 2024

(54) OPTIMIZING COST AND PERFORMANCE FOR SERVERLESS DATA ANALYTICS WORKLOADS

(71) Applicant: HEWLETT PACKARD ENTERPRISE DEVELOPMENT LP, Spring, TX (US)

(72) Inventors: FARAZ AHMED, Milpitas, CA (US); Lianjie Cao, Milpitas, CA (US); Puneet Sharma, Milpitas, CA (US)

(21) Appl. No.: 18/175,411

(22) Filed: Feb. 27, 2023

(51) Int. Cl. G06F 9/50

(52) U.S. Cl. CPC G06F 9/5083; G06F 9/5016; G06F 9/5027

(57) ABSTRACT

Systems and methods are provided for optimizing a serverless workflow. Given a directed acyclic graph (“DAG”) defining functional relationships and a gamma tuning factor to indicate a preference between cost and performance, a serverless workflow corresponding to the DAG may be optimized. The optimization is carried out in accordance with the gamma tuning factor, and is carried out in sub-segments of the DAG called stages. In addition, systems for allowing disparate types of storage media to be utilized by a serverless platform to store data are disclosed. The serverless platforms maintain visibility of the storage media types underlying persistent volumes, and may store data in partitions across disparate types of storage media. For instance, one item of data may be stored partially at a byte addressed storage media and partially at a block addressed storage media.

### BACKGROUND

Along with advances to networking and computing technology, numerous methods have been developed for handling the increasing computational demands of modern applications. One such method is cloud-computing, wherein a cloud-computing application is developed in relation to an abstract server architecture. The cloud-computing application is later executed on a real server via a virtual environment. The virtual environment enables execution of the cloud-computing application by associating the computing hardware resources available to the real server with the abstract server architecture used to develop the cloud-computing application.

Cloud-computing methods enable developers to design and run applications on a server which may be operated by a specialized provider of cloud-computing resources (e.g. Amazon Web Services®, Microsoft Azure®, Google Cloud Platform®). Further, cloud-computing methods enable developers to design and run applications on a server which may be located remotely from the developer. Cloud-computing frees the developer from having to provide computing hardware resources themselves for the cloud-computing applications they wish to run, and allows the developer to take advantage of the potentially vast resources available to such specialized providers.

Another method is serverless computing, wherein serverless applications differ from cloud-computing applications in that they may be developed without reference to an abstract server architecture. Instead, serverless applications may be described as collections of functions in a serverless workflow. The functions relate to each other by designations of inputs and outputs. Breaking the serverless workflow up into functions allows for the backend platform (e.g. a cloud-computing resource provider) to allocate functions among separate domains of computing hardware resources (“nodes”).

### BRIEF DESCRIPTION OF THE DRAWINGS

The present disclosure, in accordance with one or more various examples, is described in detail with reference to the following figures. The figures are provided for purposes of illustration only and merely depict typical or example embodiments.

FIG. 1 illustrates a system for optimizing cost and performance of a serverless workflow, in accordance with some examples of the disclosure.

FIG. 2 illustrates a map of a serverless backend application architecture, in accordance with some examples of the disclosure.

FIG. 3 illustrates the cost-performance tradeoff associated with storage of data on different storage medium types.

FIG. 4 illustrates an example DAG describing a serverless workflow, in accordance with some examples of the disclosure.

FIG. 5 illustrates an example computing component that may be used to implement methods for optimizing cost and performance of serverless workflows, in accordance with some examples of the disclosure.

FIG. 6 is an example computing component that may be used to implement various features of embodiments described in the present disclosure.

The figures are not exhaustive and do not limit the present disclosure to the precise form disclosed.

### DETAILED DESCRIPTION

The present disclosure relates to the field of serverless applications. As noted above, serverless applications can be thought of as collections of functions in a serverless workflow, where the functions relate to each other by designations of inputs and outputs. Breaking the serverless workflow up into functions allows for the backend platform (e.g. a cloud-computing resource provider) to allocate functions among separate domains of computing hardware resources (“nodes”).

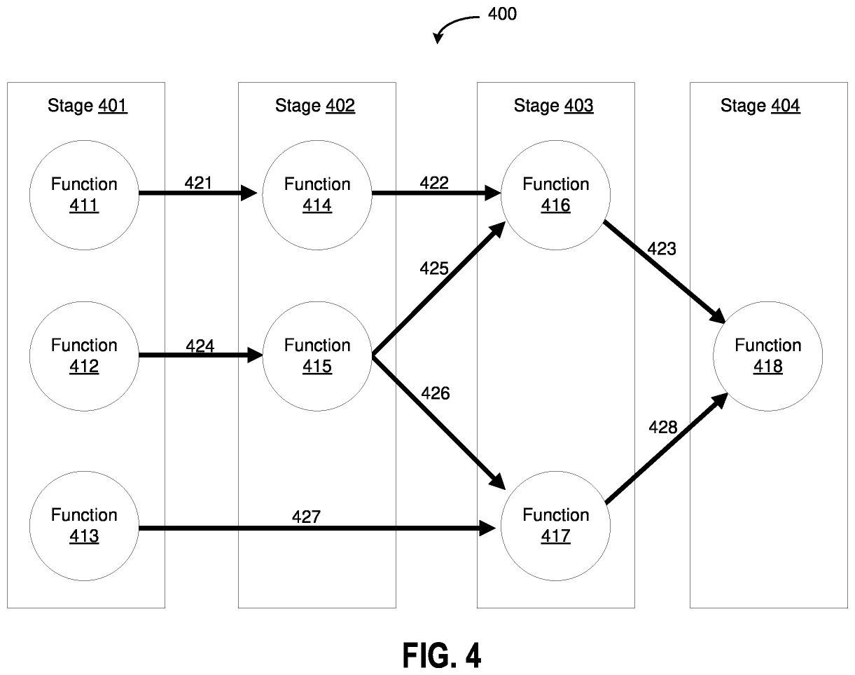

In the examples described herein, the aforementioned functions are further grouped into stages, wherein the stages comprise functions that are not dependent on the output of another function within the same or later stage. Grouping the functions into stages allows the backend platform to better allocate functions among available nodes, as each function in a stage may be executed in parallel with each other. Further, grouping the functions into stages allows the backend platform to optimize the configuration of the workflow in per stage increments, reducing overall computational burdens. In some examples, a developer may describe a serverless workflow in the form of a Directed Acyclic Graph (a “DAG”). A DAG, as illustrated below in FIG. 4, lays out each stage and its functions, with the inputs and outputs of each function defined by connecting arrows. The DAG also includes definitions for what exactly each function does to transform the function's input into the function's output. In some examples, stages may be defined differently, functions may be related to each other using different conventions, and/or no grouping of functions may be used.

Because there is no persistent server architecture defined by the serverless workflow, each output from a function is designated as being stored to some machine readable medium. Each node may have multiple types of storage medium (e.g., persistent memory (“PMEM”), Flash, solid-state drive (“SSD”), hard-disk drive (“HDD”)) available to store a given output. Each output may be stored in portions spread out across the multiple types of storage medium available at the node. In the present disclosure, outputs are defined to be stored at the node executing the function and each node are defined to contain a set of processing resources, storage media, storage read/write throughput resources, and network resources. Inputs to a function are understood to be transferred from the node where the data being input was generated. In some examples, nodes may be defined to contain less than all the available sets of processing resources or types of storage medium. In some examples, outputs may be defined to be stored at nodes other than the executing node.

A node executing an earlier stage function may yield data as an output which is defined by a DAG to be used as an input in a later stage function. In some cases, the node executing the earlier stage function may be the same node as the node executing the later stage function. In situations where the earlier stage function executing node is the same as the later stage function executing node, no transfer of the input data takes place, saving on the time, storage read/write throughput, and network resources used to transfer the data between the nodes. However, other considerations (e.g., write speed of available storage media at the given node, the price of further computation at the given node) may make it advantageous in terms of overall workflow cost and/or performance to execute functions on separate nodes. This highlights only one of numerous decisions that are made before executing a serverless workflow.

Ultimately, to execute a serverless workflow, each function within the next unexecuted stage is allocated to a specific node, and the storage characteristics of each output (e.g. how much of the output is stored at the which available storage medium) are defined. These allocations and definitions for a given stage (referred to herein as the “serverless workflow stage configuration”) may be completed on the backend or the front end, by the cloud-computing resource provider or by the developer. In some examples, all functions may be grouped in one stage, or there may be no stages, in which case the serverless workflow stage configuration defines the entire serverless workflow's deployment at once. The present disclosure relates to systems and methods for determining at least one serverless workflow stage configuration that optimizes the cost and performance of the serverless workflow.

In some examples, a scheduler for comparing the overall cost and performance of each possible serverless workflow stage configuration for the next stage in a developer supplied DAG may be employed. The scheduler weighs its comparison based on a gamma tuning factor supplied by a developer. The gamma tuning factor is a real number between 0 and 1 designating the developers preference for cost as compared to performance. The scheduler then deploys the serverless workflow configuration with the best scoring cost and performance according to the gamma tuning factor (the “optimal” serverless workflow stage configuration). The scheduler deploys the optimal serverless workflow configuration by assigning the workflow's functions for execution at the nodes specified in the configuration, and assigning the outputs of the associated functions to the storage media specified in the configuration. The scheduler repeats this process at each stage of the developer supplied DAG until all stages of the supplied DAG have been executed.

In some examples, optimizing the cost and performance of a serverless workflow can be achieved by enabling the utilization of multiple heterogeneous storage types at a single node. Multiple types of storage media (e.g., PMEM, Flash, SSD, HDD) may be available at a node. Where multiple types of storage resources are available at a node, different containerization methods are implemented and/or combined to enable the serverless application to expose all storage resources as persistent volumes. For instance, where block-addressed storage is containerized, Container Storage Interface (CSI) plug-ins may be used, but where byte-addressed storage like PMEM is being containerized, specialized containerization methods like pmem-csi may be employed. The present disclosure contemplates employing specialized byte-addressed containerization methods, like pmem-csi, in addition to block-addressed containerization methods, like CSI, where nodes on a network include both byte-addressed and block-addressed storage resources.

These containerization methods may further be employed at the backend to allow the serverless platform (e.g. Lithops, PyWren, OpenLambda, OpenWhisk, Kubernetes) visibility regarding which input and/or output is stored to which storage type available at a node. In some examples, the containerization methods may be designated at the frontend, and/or employed by the developer. With more varied types of storage media available at a given node, the function-node allocations and the output-type definitions may be made in a way that better tailors the cost and performance of the serverless workflow stage configuration to the wishes indicated by the developer in the gamma tuning function.

When employing the systems and methods disclosed herein, a developer may not need to be exposed to such complexities regarding output storage characteristics and function-node allocations, and may instead only specify the DAG and a gamma tuning factor.

Data analytics may require the handling of large amounts of intermediate data, and thus the described systems and methods may be helpful in the field of serverless data analytics workflows, where the systems and methods may reduce demands on storage read/write throughput resources. However, the disclosure herein is not limited to the field of data analytics, and may be applicable wherever serverless applications are employed.

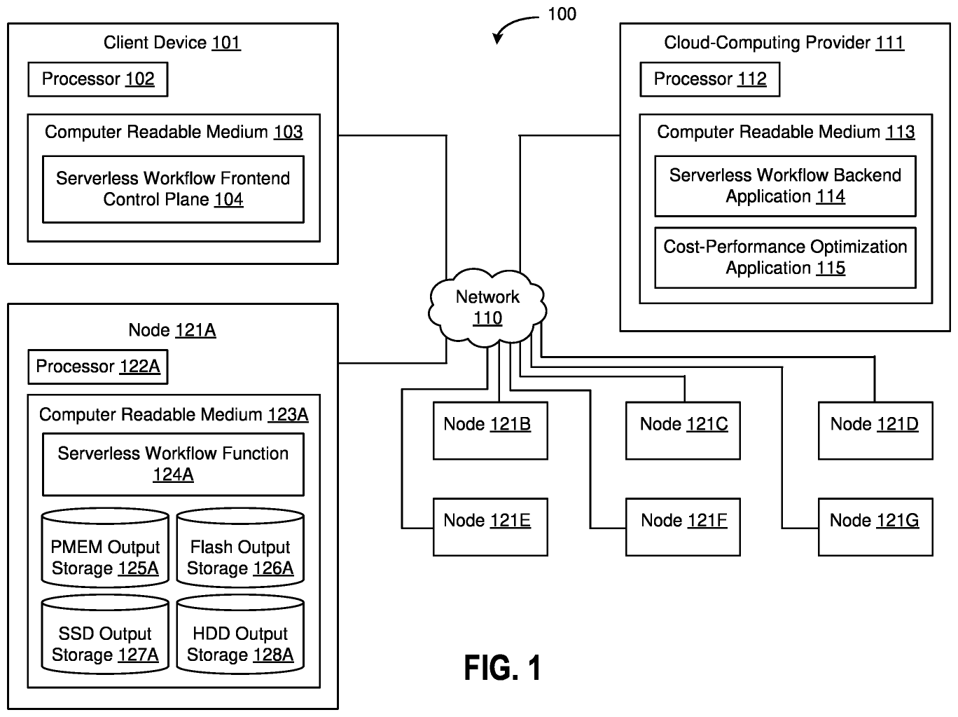

FIG. 1 illustrates a system 100 for optimizing cost and performance of a serverless workflow, in accordance with some examples of the disclosure. The system 100 may comprise client device 101 in communication with cloud-computing provider 111 and nodes 121A-G via network 110. Client device 101 may comprise processor 102, cloud-computing provider 111 may comprise processor 112, and nodes 121A-G may comprise processors 122A-G, respectively. Further, client device 101 may comprise computer readable medium 103, cloud-computing provider 111 may comprise computer readable medium 113, and nodes 121A-G may comprise computer readable media 123A-G, respectively. Such computer readable media may comprise one or more applications or control planes, as discussed herein.

Processor(s) 102, 112, and/or 122A-G may each represent one or more central processing units (CPUs), semiconductor-based microprocessors, and/or other hardware devices suitable for retrieval and execution of instructions stored in computer readable medium (media) 103, 113, and/or 123A-G. Processor(s) 102, 112, and/or 122A-G may each fetch, decode, and execute instructions to control processes or operations for optimizing the system during run-time. As an alternative or in addition to retrieving and executing instructions, processor(s) 102, 112, and/or 122A-G may each include one or more electronic circuits that include electronic components for performing the functionality of one or more instructions, such as a field programmable gate array (FPGA), application specific integrated circuit (ASIC), or other electronic circuits. As used herein, for convenience, the various instructions may be described as performing an operation, when, in fact, the various instructions program processor(s) 102, 112, and/or 122A-G to perform the operation. Similarly, where a computing device is disclosed as performing an operation, in fact the computing device's associated processor(s) perform the operation upon execution of associated instructions.

Computer readable medium (media) 103, 113, and/or 123A-G may each comprise a random access memory (RAM), cache, and/or other dynamic storage devices, coupled to a bus for storing information and instructions to be executed by an associated processor(s) 102, 112, and/or 122A-G. Computer readable medium (media) 103, 113, and/or 123A-G also may each be used for storing temporary variables or other intermediate information during execution of instructions to be executed by an associated processor(s) 102, 112, and/or 122A-G. Such instructions, when stored in storage media accessible to an associated processor(s) 102, 112, and/or 122A-G, render computer system(s) 101, 111, and/or 121A-G into special-purpose machines that are customized to perform the operations specified in the instructions.

In addition, computer readable medium (media) 103, 113, and/or 123A-G may each comprise an electronic, magnetic, optical, or other physical storage device that contains or stores executable instructions. Thus, computer readable medium (media) 103, 113, and/or 123A-G may each comprise, for example, Random Access Memory (RAM), non-volatile RAM (NVRAM), an Electrically Erasable Programmable Read-Only Memory (EEPROM), a storage device, an optical disc, and the like. As described in detail below, Computer readable medium (media) 103, 113, and/or 123A-G may be encoded with executable instructions.

Client device 101 may implement one or more applications and/or control planes within computer readable medium 103, including serverless workflow frontend control plane 104.

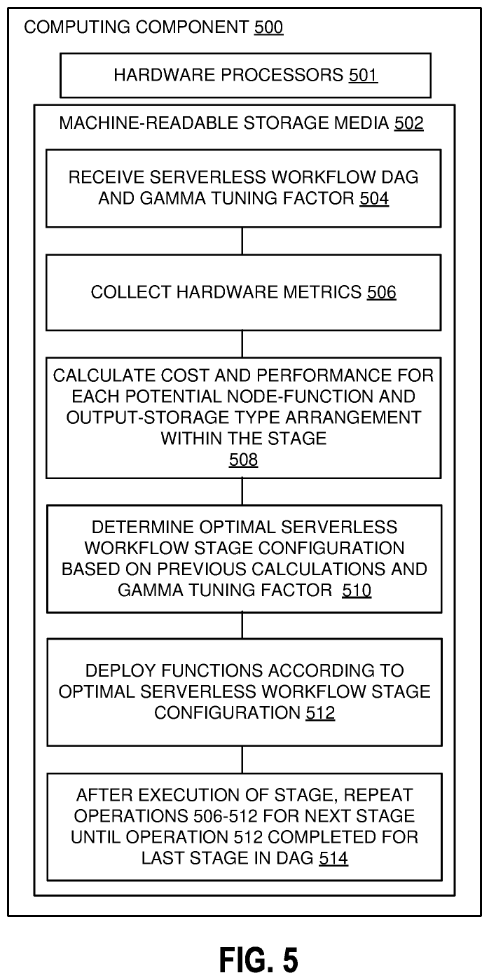

In the disclosed example, serverless workflow frontend control plane 104 may comprise a user interface wherein a developer may specify parameters defining a serverless workflow. As described in more specific detail below regarding FIG. 4, a developer may provide a DAG to define the input/output relationships between functions within a serverless workflow, as well as the functions themselves and their stage groupings. As described in more specific detail below regarding FIG. 5, the developer may provide a gamma tuning factor to specify how the developer would like gains in cost weighed against gains in performance when determining the optimal serverless workflow configuration. In some examples, the developer may provide a different suite of parameters not herein described, but still defining the same concepts.

Client device 101 may transmit the parameters to the cloud-computing provider 111 via the network 110. Cloud-computing provider 111 may implement one or more applications and/or control planes within computer readable medium 113, including serverless workflow backend application 114, and cost-performance optimization application 115.

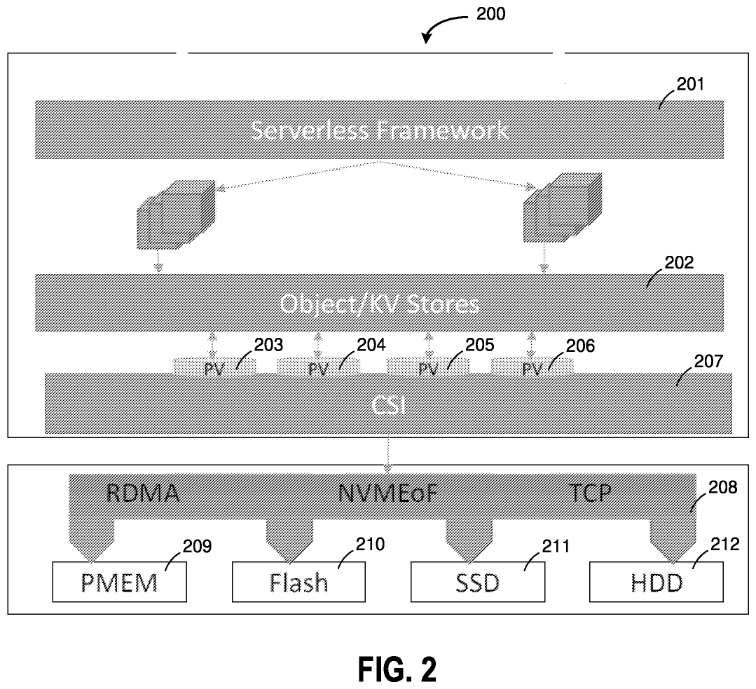

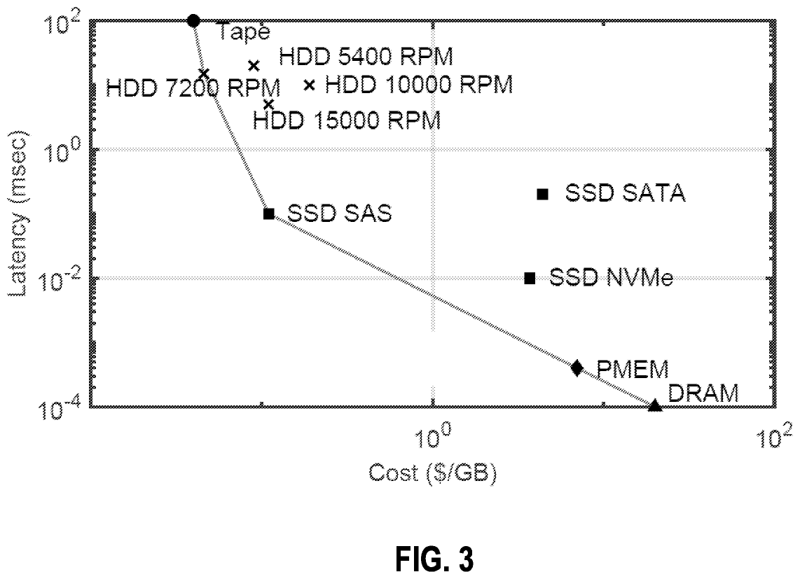

In the disclosed example, serverless workflow backend application 114 may comprise a serverless platform (e.g., Lithops, PyWren, Open-Lambda, OpenWhisk, Kubeless) running in a cloud-computing environment (e.g. Kubernetes). The serverless workflow backend application 114 may provide backend services which enable deployment of a serverless workflow. Examples of such backend services may include containerizing applications, provisioning available storage mediums as persistent storage volumes, provisioning available computation resources as nodes, and/or enabling storage of data to in-memory Key-Value (or object) stores. As further discussed in relation to FIGS. 2-3, where disparate storage types are to be exposed for utilization by the serverless workflow, such provisioning may be accomplished through the utilization of storage interfaces by the serverless workflow backend application 114.

In the disclosed example, cost-performance optimization application 115 may comprise an application wherein the developer supplied parameters are used to determine the optimal serverless workflow stage configuration. As described in more specific detail below regarding FIG. 5, the supplied parameters may include a DAG and/or gamma tuning factor. In some examples, the optimal serverless workflow stage configuration may be found by first calculating the cost and performance at each potential serverless workflow stage configuration for a given stage. The optimal serverless workflow stage configuration is then determined by choosing the best weighted score according to the gamma tuning factor. Other examples may employ any methodology for determining the optimal serverless workflow configuration given parameters defining the same concepts associated with the DAG and gamma tuning factor as described herein.

Once the optimal serverless workflow configuration has been determined, the serverless workflow backend application 114 may deploy the optimal serverless workflow configuration to the available nodes 121A-G. In some examples, the deployment instructions are part of a scheduler application defined in computer readable medium 113. Deployment of the optimal serverless workflow configuration is achieved by assigning the workflow stage's functions for execution at the nodes specified in the optimal serverless workflow stage configuration, and assigning the outputs of the associated functions to the storage media specified in the configuration.

Cloud-computing provider 111 may deploy the optimal serverless workflow configuration via instructions and data sent via the network 110 to nodes 121A-G. Node 121A is disclosed in more detail herein, however nodes 121B-G may comprise the same or substantially similar components as Node 121A. Node 121A's associated computer readable medium 123A may comprise one or more function definitions and/or one or more output storage locations grouped by storage type. The disclosed example illustrates only seven nodes 121A-G, however other examples may include any number of nodes.

Serverless workflow function 124A may comprise a function associated with a serverless workflow stage deployed to node 121A by cloud-computing provider 111. The serverless workflow function runs as defined in the developer provided DAG, with its outputs being stored among available output storage types. The outputs of the function are stored according to the determined optimal serverless workflow stage configuration. The inputs of the function may be at node 121A, or at a remotely located node 121B-G. Where the input is located remotely, the input data may be transferred over network 110 to node 121A before execution of serverless workflow function 124A.

Node 121A is illustrated as comprising several output storage locations grouped by type: PMEM Output Storage 125A, Flash Output Storage 126A, SSD Output Storage 127A, and HDD Output Storage 128A. These represent the different types of storage media that may be present at node 121A, however in some examples further types of storage media may be present at node 121A. These specific output storage locations are disclosed herein to give an understanding of how node 121A may store data output from serverless workflow function 124A at numerous types of storage media available at the node. In some examples, node 121A may store data output from serverless workflow function 124A in portions, with portions stored at disparate types of storage media. As discussed above and below, how exactly a given output from serverless workflow function 124A is to be stored across the storage media types available at node 121A is defined during deployment of the optimal serverless workflow stage configuration to node 121A. As discussed in relation to FIG. 3 below, storage of outputs on a given storage type may impact the cost and/or performance of running the workflow.

In some examples, network 110 may comprise an internet, wherein each of devices 101, 111, and 121A-G are located remotely across an internet connection. In some examples, network 110 may comprise a local-area network (“LAN”) or intranet connection, wherein each of devices 101, 111, and 121 are located locally with each other. In some examples, some of devices 101, 111, and 121 are located locally with each other, and others of devices 101, 111, and 121 are located remotely from each other. In some examples any combination of devices 101, 111, and 121A-G may be implemented at the same machine, e.g., the same device may implement the frontend control plane 104, backend application 114, and a number of nodes 121A-G of system 100.

FIG. 2 illustrates a map 200 of a serverless backend application architecture, in accordance with some examples of the disclosure. In some examples, a serverless platform (e.g. Lithops, PyWren, OpenLambda, OpenWhisk, Kubernetes) supports a serverless framework 201. The serverless framework 201 enables the storage of function data into abstract object and/or key-value store listing 202. The object and/or key-value store listing 202 comprises a series of persistent volumes 203-206. The underlying storage media are able to be exposed as abstract persistent volumes 203-206 via the utilization of a suite of container storage interfaces (“CSIs”) 207. The CSIs 207 are able to interface with storage media sometimes located on machines remote from the device executing the serverless application via the utilization of a suite of direct access interfaces 208 (e.g., remote direct memory access (RDMA), non-volatile memory express over fabrics (NVMEoF), Transmission Control Protocol (TCP)). This overall architecture ultimately allows the serverless framework to utilize available storage media 209-212 despite the storage media employing disparate storage types (e.g., PMEM, flash, SSD, HDD). The disclosed backend application architecture map 200 is non-limiting, and the disclosed examples can be implemented by a serverless backend engine architecture organized differently from map 200 disclosed in FIG. 2.

Visibility at the object and/or key-value store listing 202 regarding which type of underlying storage media may be used to contain the stored object may enable greater flexibility in configuring serverless workflow stage configurations. In order to achieve visibility, persistent volume 203-206 may employ storage containerization schemes which associate each persistent volume 203-206 with a specific type of available storage media. The serverless workflow backend application may then more flexibly configure the serverless workflow stage configuration by choosing a persistent volume associated with a storage type. The persistent volumes may also expose hardware metrics regarding the underlying storage media with the storage type matching the persistent volume. Outputs may also be partitioned and stored across multiple different persistent volumes.

One specific example of this containerization scheme is accomplished by containerizing PMEM according to a PMEM specific CSI, pmem-csi, while containerizing SSD according to a traditional SSD CSI. The storage media containerized using pmem-csi are associated with a first persistent volume, while storage media containerized using traditional SSD CSI are associated with a second persistent volume. In addition to maintaining visibility of available storage types at the object and/or key-value store listing 202, utilizing a combination of CSIs allows for disparate types of storage data to store a function output. Previously, where byte addressed storage media like PMEM was used, only other byte addressed storage types could be used to store an output due to the uniformity of addressing and specialized communication interfaces needed when handling an object. Containerization with pmem-csi and traditional CSI methods at the serverless workflow backend allows for byte addressed storage types to be used in conjunction with block storage types (e.g. SSD, HDD) to store a given object. Availability of both block addressed and byte addressed storage media as options for output storage allows for greater flexibility in finding an optimal serverless workflow configuration.

FIG. 3 illustrates the cost-performance tradeoff associated with storage of data on different storage medium types. The disclosed data was not collected by Applicant and only represents the rough relationship of each type of storage medium depicted regarding the disclosed metrics. Latency on the vertical axis represents the time in msec that the storage type takes to complete a read or write request. Cost on the horizontal axis represents the cost in dollars for a GB of storage in the storage type. A person of skill in the art understands that storage media types differ in many other characteristics beyond latency and cost, and such other characteristics may also be accounted for by the systems and methods disclosed herein. Further, the disclosed storage medium types are non-limiting, and the disclosed examples can be implemented with storage medium types not disclosed in FIG. 3.

As shown in FIG. 3, storage types like tape drives may provide relatively inexpensive data storage (roughly $0.05 per GB of storage), at relatively high latency (roughly 100 msec). On the other hand, dynamic random access memory (“DRAM”) may provide relatively expensive data storage (roughly $20 per GB of storage), at relatively low latency (roughly 0.0001 msec latency). Other types of storage media disclosed in FIG. 3 (HDD at 5400 RPM, 7200 RPM, 10000 RPM, and 15000 RPM, SSD serial-attached SCSI (“SAS”), SSD serial AT attachment (“SATA”), SSD non-volatile memory express (“NVMe”)) may provide latency and cost characteristics at values between these extremes. Other undisclosed and/or yet uninvented storage media types may provide latency and cost characteristics outside of these extremes.

The sensitivity to storage latency may be increased in serverless applications with heavy read/write requirements. For instance, where multiple serverless functions are being executed in parallel on separate nodes and depend on a single output, the time it takes to read from the storage media where the single output is stored may be multiplied for each parallel function reading the output in sequence. In instances where the performance of the overall workflow is sensitive to storage latency, providing added flexibility in how exactly the output data is stored enables the determination of more optimal serverless workflow stage configurations.

FIG. 4 illustrates an example DAG 400 describing a serverless workflow, in accordance with some examples of the disclosure. The DAG 400 provides a visual description of how the functions within a serverless workflow relate to each other. Though not depicted in FIG. 4, the DAG 400 is also defines how each function translates its inputs to its outputs. These definitions may take the form of a function picked from a library of known functions, explicit executable instructions, algorithms output from trained (or to-be-trained) machine learning algorithms, or any other form of defining a function in terms executable by a processor.

Stages 401, 402, 403, and 404 are all depicted comprising at least one function. Stage 401 comprises functions 411, 412, and 413. Stage 402 comprises functions 414 and 415. Stage 403 comprises functions 416 and 417. Stage 404 comprises function 418. The output-to-input relations between the functions are defined by the output-to-input arrows 421-428. Where an arrow is depicted, an output from one function is used as an input for another function. For instance, an output of function 411 serves as an input for function 414, based on the output-to-input arrow 421 starting at function 411 and pointing to function 414.

Outputs from one function may be preserved while waiting to be read as input for at least one later function. Each output-to-input relation on the disclosed DAG 400 may be understood to also represent an instance where an output is stored at a machine readable media. In some examples, the output may be partitioned and stored among multiple types of machine readable media. In the disclosed example, outputs are conceptualized as being written to machine readable media located at whichever node executed the outputting function. Where later functions are deployed to a different node and wish to use the output as an input, the output data may be transferred from the node deploying the outputting function to the node deploying the inputting function. In some examples, this convention may be reversed wherein output data is automatically stored at each node deploying an inputting function. In any case, where the outputting function and the inputting function are both deployed by the same node, then the output data may not need to be transferred to another storage medium before executing the inputting function. The serverless workflow has been completely executed once all functions have executed and stored their output to a machine readable medium (media).

Functions are disclosed herein as grouped into stages, wherein no input of a function in a stage depends from a function in the same or later stage. For instance, functions 416 and 417 may be grouped together into stage 403 as depicted because functions 416 and 417 do not have inputs which depend from functions 416, 417 of the same stage 403, or from function 418 of later stage 404. Where multiple functions are grouped in a stage, the functions may be executed in parallel once all prior stages complete execution, e.g., function 416 and 417 may be deployed to separate nodes and executed at the same time once the functions in stages 401 and 402 complete.

In the disclosed example, the developer defines the DAG by defining functions 411-418, the output-input arrows 421-428, and which functions belong to stages 401-404. In some examples, the serverless workflow backend application may define the stages 401-404. In the disclosed example, and as described in more detail regarding FIG. 5, the serverless workflow backend application deploys a serverless workflow stage configuration for one stage at a time. After a stage executes, the serverless workflow backend deploys the serverless workflow stage configuration for the next stage. For a given function, the serverless workflow backend application may determine which node will execute the given function, and which storage medium (media) will store the output(s) of the function. To have a complete serverless workflow stage configuration ready for deployment, the serverless workflow backend application makes these determinations for each function at the given stage, and for each output of each function.

FIG. 5 illustrates an example computing component 500 that may be used to implement methods for optimizing cost and performance of serverless workflows, in accordance with some examples of the disclosure. Computing component 500 may be, for example, a client device 101, cloud-computing provider 111, a node 121A-G, or any other similar computing component capable of processing data. In the example disclosed in FIG. 5, computing component 500 may be conceptualized as a cloud-computing provider 111 with a serverless workflow backend application 114 and cost-performance optimization application 115 stored in its computer readable medium 113. Computing component 500 includes hardware processor(s) 501 and machine-readable storage medium (media) 502.

Hardware processor(s) 501 may be analogous to processor(s) 112 as disclosed in relation to FIG. 1. Hardware processor 501 may be one or more central processing units (CPUs), semiconductor-based microprocessors, and/or other hardware devices suitable for retrieval and execution of instructions stored in machine-readable storage medium 502. Hardware processor 501 may fetch, decode, and execute instructions, such as instructions associated with operations 504-512, to control processes or operations for network-aware resource allocation. As an alternative or in addition to retrieving and executing instructions, hardware processor 501 may include one or more electronic circuits that include electronic components for performing the functionality of one or more instructions, such as a field programmable gate array (FPGA), application specific integrated circuit (ASIC), or other electronic circuits.

Machine-readable storage medium (media) 502 may be analogous to computer readable medium 113 as disclosed in relation to FIG. 1. A machine-readable storage medium, such as machine-readable storage medium 502, may be any electronic, magnetic, optical, or other physical storage device that contains or stores executable instructions. Thus, machine-readable storage medium 502 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 502 may be a non-transitory storage medium, where the term “non-transitory” does not encompass transitory propagating signals. As described in detail below, machine-readable storage medium 502 may be encoded with executable instructions, for example, instructions associated with operations 504-514.

Machine-readable storage medium (media) 502 is illustrated as storing a method for optimizing the cost and performance of a serverless workflow, with the method separated into operations 504 through 514. In some examples, operations 504 through 514 may be conceptualized as being carried out under an application, control plane, application, etc. For instance, operations 504 and 512 may be conceptualized as being carried out under serverless workflow backend application 114, and operations 506-510 and 514 may be conceptualized as being carried out under cost-performance optimization application 115. In some examples, all of operations 504 through 512 may be conceptualized under any number of applications, control planes, applications, etc., including under applications, control planes, applications, etc. not disclosed herein.

As used herein, for convenience, the various instructions may be described as performing an operation, when, in fact, the various instructions program processor to perform the operation. Similarly, where a computing device is disclosed as performing an operation, in fact the computing device's associated processor(s) perform the operation upon execution of associated instructions. Further, operations 504-414 are disclosed in a top down order, however this order is not limiting. In some examples, a similar or identical resulting optimization of a serverless workflow may be achieved through a method with the disclosed operations taking place in a different order.

At operation 504, a serverless workflow DAG and gamma tuning factor is received by computing component 500. In some examples, this is received over a network from a client device running a serverless workflow frontend control plane to generate the serverless workflow DAG and gamma tuning factor based on inputs from a developer. In some examples, a developer may provide a serverless workflow DAG and gamma tuning factor via a serverless workflow frontend control plane executing at the computing component 500.

As described in relation to FIG. 4, the serverless workflow DAG defines at least the output-input relations between the functions of the serverless workflow, the functions themselves, and the stages for the functions of the serverless workflow. The stages allow for parallel execution of the functions within the stage, and for separation of the optimization calculations into stages of the serverless workflow.

The gamma tuning factor is a real number between 0 and 1 designating the developer's preference for cost as compared to performance. For instance, where the developer values cost significantly higher than performance a gamma tuning factor of 0 may be chosen, resulting in a serverless workflow stage configuration that executes at the absolute minimum cost of all serverless workflow stage configurations. Where the developer values performance significantly higher than cost, a gamma tuning factor of 1 may be chosen, resulting in a serverless workflow stage configuration that executes with the absolute highest performance (e.g., fastest) of all possible serverless workflow stage configurations. Where the developer values cost the same as performance, a gamma tuning factor of 0.5 may be chosen, resulting in a serverless workflow stage configuration that is balanced somewhere between the previous two. In the disclosed example the gamma tuning factor may take on any real number between 0 and 1, but in other examples the gamma tuning factor may be scaled to any range of numbers.

At operation 506, hardware metrics are collected. In some examples, these metrics are collected from a library containing previously defined metrics for the associated hardware. In some examples, these metrics are collected by direct measurement by the nodes themselves, computing component 500, a client device, or any device communicatively coupled to the computing component 500. In some examples, these metrics are collected from a machine learning algorithm trained (or to-be-trained) on measurements relating to the hardware. Where the associated library, measurements, and/or machine learning algorithm are located remotely from computing component 500, the library, measurements, and/or machine learning algorithm may be communicated to the computing component 500. These metrics may be updated before, during, or after execution of functions comprising the serverless workflow stage. In some examples, some of the metrics may be rough estimates and/or predictions of future hardware behavior.

The collected metrics are relevant to determining the cost and/or performance of a prospective serverless workflow stage configuration. Example metrics may include: the read time for a specific storage medium, the write time for a specific storage medium, the time to transfer data over a specific network pathway, the time taken for a specific processor to process a specific amount of data, available capacity on a specific storage medium, dollar per byte of storage at a specific storage medium, dollar per processor cycle of a specific processor, dollar per byte of data transmitted over a specific network pathway. Numerous other metrics may be used instead of or in addition to those disclosed herein to determine the cost and/or performance of a prospective serverless workflow stage configuration.

At operation 508, the cost and performance for each potential node-function and output-storage type arrangement within the stage are calculated. This operation may include many calculations, as the number of potential node-function and output-storage type arrangements grows quickly as the number of nodes and storage types available at each node increases. For instance, using stage 401 of DAG 400 disclosed in FIG. 4, assuming a 100 node system and 100 different storage type arrangements available for each output, there are at least 30,000 potential arrangements. For each of the three functions in stage 401 there are 100 nodes where they may store their outputs, and for each of those outputs storages, there are 100 different storage type arrangements. This translates to 3*100*100 (or 30,000) potential node-function and output-storage type arrangements. This calculation is provided only to illustrate how many configurations may be at hand to complete operation 508, other examples may have any number of nodes and storage type arrangements. Storage type arrangements may be numerous where partial storage of an output across multiple storage media is considered.

At each of the potential node-function and output-storage type arrangements, the cost and performance may be calculated. To calculate the cost, the cost in terms of dollar per byte stored, dollar per byte executed, and dollar per data transferred over the network may be calculated at least for every function within the stage. To calculate the performance, the time in terms of latency may be calculated for each read, write, and processor cycle associated with every function within the stage. These calculations are based on the metrics obtained at operation 506 and the node-function and output-storage type arrangement. Both the cost and performance calculations may be repeated for each potential node-function and output-storage type arrangement. For instance, using stage 401 of DAG 400 disclosed in FIG. 4, assuming a 100 node system and 100 different storage type arrangements available for each output, the cost and performance calculations may be repeated for at least each of the 30,000 arrangements.

In some examples, numerous calculations may be skipped where they have already been made in an identical or similar previous calculation.

In some examples, constraints may be applied in defining a potential node-function and output-storage type arrangement. Where such constraints are applied, they may reduce the number of calculations performed to determine an optimal serverless workflow stage configuration.

In some examples, potential node-function and output-storage type arrangements are constrained to those where each function's output is stored only at storage media present at the node where the function is executed.

In some examples, potential node-function and output-storage type arrangements are constrained to those where each function's output is stored only once.

In some examples, potential node-function and output-storage type arrangements are constrained to those where the total amount of data output by a function does not exceed the storage capacity available at the node executing the function.

In some examples, potential node-function and output-storage type arrangements are constrained to those where there are sufficient processing resources available at a node to execute all the functions designated for execution at the node.

In some examples, potential node-function and output-storage type arrangements are constrained to those where there are sufficient memory (volatile data storage) resources available at a node to execute all the functions designated for execution at the node.

In some examples, potential node-function and output-storage type arrangements are constrained to those where executing all functions assigned to write to a given storage medium will not overload the given storage medium's limitations on concurrent writes.

In some examples, potential node-function and output-storage type arrangements are constrained to those where executing all functions assigned to read from a given storage medium will not overload the given storage medium's limitations on concurrent reads.

In some examples, potential node-function and output-storage type arrangements are constrained to those where the transfer of inputs to the nodes executing functions utilizing the inputs will not overload the associated network connections.

At operation 510, the optimal serverless workflow stage configuration is determined based on the calculations completed at operation 506 and the gamma tuning factor. In some examples, this is accomplished by multiplying the gamma tuning factor (“γ”) by the calculated performance in terms of time, multiplying (1−γ) by the calculated cost in terms of dollars, and then summing the result of these two calculations. This is done for each serverless workflow stage configuration, and then the optimal serverless workflow stage configuration is chosen as the serverless workflow stage configuration with the lowest summed result of the two calculations.

As a person of skill in the art will readily understand, such calculations based on γ result in γ acting as a tuning factor defining how the developer weighs cost compared with performance of the serverless workflow. Where the developer chooses a γ of 0.9, the serverless workflow stage configuration with the lowest summed result of the two calculations above is going to skew more toward configurations wherein the performance in terms of time is minimized. Conversely, where the developer chooses a γ of 0.1, the serverless workflow stage configuration with the lowest summed result of the two calculations above is going to skew more toward configurations wherein the cost in terms of dollars is minimized. A higher gamma can be said to indicate the developer's preference for faster performance, while a lower gamma can be said to indicate the developer's preference for lower cost. In some examples, γ may be applied to the calculated cost and/or performance differently, with the same result that γ approximates a preference between cost and performance of the serverless workflow.

The following Table 1 and Equations 1-7 define a specific example methodology for determining an optimal serverless workflow stage arrangement. The specific methodology disclosed herein can be understood to be occurring during operations 506-510 in examples where the specific methodology is employed. This is a non-limiting example that could be used to do the calculations described herein. The resulting cost and performance of a given output-storage type arrangement may be calculated via many other methods, as long as the methods follow the abstract guidance given above regarding operations 508 and 510.

TABLE 1
Summary of notation for example equations.

| Notation | Definition |
|---|---|
| fᵢ | i-th function of the subject serverless workflow stage |
| | configuration |
| γ | gamma tuning factor |
| s | node where the input to fᵢ is sourced |
| d | node where the fᵢ is executed |
| k | storage medium of s where the input to fᵢ is read from |
| k′ | storage medium of d where the output of fᵢ is written to |
| o_{i, s}^{k} | bytes of data to be read by function fᵢ on storage k of node s |
| e_{i, d}^{k}′ | bytes of data to be written by function fᵢ on storage k′ of |
| | node d |
| D^{k} | I/O throughput (bytes per second readable/writable) for |
| | storage medium k |
| rᵢ | total time to read for function fᵢ |
| b_{sd}^{k} | network throughput (bytes per second transferrable) from node |
| | s to d using |
| | network compatible with storage k |
| t_{i, sd}^{k} | time to transfer from node s to d using network compatible |
| | with storage k |
| w_{i, d}^{k}′ | time to write by function fᵢ on storage k′ of node d |
| x_{i, d}^{k}′ | fraction of output data to be written by function fᵢ on storage |
| | k′ of node d |
| pᵢ | total time to process data for function fᵢ |
| c^{k}′ | cost of storage at k′ per byte |
| q_{i, d}^{k}′ | cost of e_{i, d}^{k}′ bytes of data |
| Tᵢ | total time to execute fᵢ |
| c(Tᵢ) | computation cost of executing fᵢ (scales with Tᵢ) |

$${r}_{i} = {\sum }_{s , k} \frac{{o}_{i s}^{k}}{{D}^{k}} \qquad Equation 1$$

$${t}_{i , sd}^{k} = \frac{{o}_{i , s}^{k}}{{b}_{s d}^{k}} , ( where s = d , {t}_{i , sd}^{k} = 0 ) \qquad Equation 2$$

$${w}_{i , d}^{{k}^{′}} = \frac{{e}_{i , d}^{{k}^{′}}}{{D}^{{k}^{′}}} \qquad Equation 3$$

$${q}_{i , d}^{{k}^{′}} = {e}_{i , d}^{{k}^{′}} \times {c}^{{k}^{′}} \qquad Equation 4$$

$$Minimize \{ γ {\sum }_{i} [ {r}_{i} + {p}_{i} + {\sum }_{d} {\sum }_{{k}^{′}} {x}_{i , d}^{{k}^{′}} ( {w}_{i , d}^{{k}^{′}} + {\sum }_{s , k} {t}_{i , sd}^{k} ) ] + ( 1 - γ ) [ {\sum }_{i , sd , {k}^{′}} {q}_{i , d}^{{k}^{′}} {x}_{i , d}^{{k}^{′}} + c ( {T}_{i} ) ] \} \qquad Equation 5$$

$$Minimize {\sum }_{i} [ {r}_{i} + {p}_{i} + {\sum }_{d} {\sum }_{{k}^{′}} {x}_{i , d}^{{k}^{′}} ( {w}_{i , d}^{{k}^{′}} + {\sum }_{s , k} {r}_{i , sd}^{k} ) ] \qquad Equation 6$$

$$Minimize {\sum }_{i , sd , {k}^{′}} {q}_{i , d}^{{k}^{′}} {x}_{i , d}^{{k}^{′}} + c ( {T}_{i} ) \qquad Equation 7$$

The specific methodology disclosed herein begins by collecting the metrics in Table 1, except in cases where the metrics are derived from Equations 1-4. Where the metrics are derived from Equations 1-4, they are derived for each associated function ƒᵢ in the stage, potential input storage node s, potential output storage node d, input storage medium k, and output storage medium k′. Using these metrics, the overall cost in terms of dollars and performance in terms of execution time for a stage in the workflow can be determined, for all possible configurations of function-node and output-storage type, in terms of an optimization variable x. Optimization variable x denotes the fraction of a function's output written to a given storage media k′. Note that there is an optimization variable for at least every available storage media at node d.

Optimization variable x is then varied between 0 and 1 for each function-node configuration of the stage and each storage media available at each node, and a cost and performance is calculated at each value of optimization variable x. An x value of 0 means that none of the function's output is written to the storage media k′ and an x value 1 means that all of the function's output is written to the storage media k′. Where x is a fraction, the output is partially stored at the storage media k′, with the remainder of the output stored to a one or more other storage media. The granularity of x values between 0 and 1 (e.g. 0.1, 0.2, 0.3, . . . vs 0.01, 0.02, 0.03, . . . ) may be varied depending on the preferences of the developer or the configuration of the cost-performance optimization application. The optimal serverless workflow stage configuration is then chosen based on the combination of function-node, storage media, and x values that yields the lowest result of Equation 5.

As can be appreciated by one of skill in the art, and as discussed above regarding operation 510, the presence of gamma tuning factor γ in Equation 5 results in γ acting as a tuning factor defining how the developer weighs cost compared with performance of the serverless workflow. Where γ is 1, Equation 5 simplifies to Equation 6, and the serverless workflow stage configuration resulting in the fastest performance is selected. Where γ is 0, Equation 5 simplifies to Equation 7, and the serverless workflow stage configuration resulting in the lowest cost is selected.

At operation 512, the stage's functions are deployed according to the optimal serverless workflow stage configuration determined in operation 510. In some examples, this is accomplished by a scheduler implemented in the serverless workflow backend application. In some examples, a different application, control plane, or application may be utilized to deploy the optimal serverless workflow stage configuration using similar methods. The scheduler deploys the optimal serverless workflow stage configuration by sending each of the stage's functions to the node designated in the optimal serverless workflow stage configuration. The scheduler also sends instructions detailing how the output of each of the stage's functions are to be stored to the associated node's storage media, as designated in the optimal serverless workflow stage configuration. The serverless workflow stage may then be executed by the associated nodes.

At operation 514, after the functions of the stage have completed execution, operations 506-512 are repeated for the next stage in the serverless workflow DAG. In some examples metrics collected at operation 506 may have not changed and/or their collection may be skipped without undermining the ability of the computing component 500 to determine an optimal serverless workflow stage configuration for the next stage. Operations 506-512 are repeated until the last stage in the serverless workflow DAG has been executed. The result of executing operations 506-512 at each stage is an overall optimized serverless workflow execution, wherein each stage was executed according to a supplied serverless workflow DAG and cost vs. performance preference denoted by a gamma tuning factor.

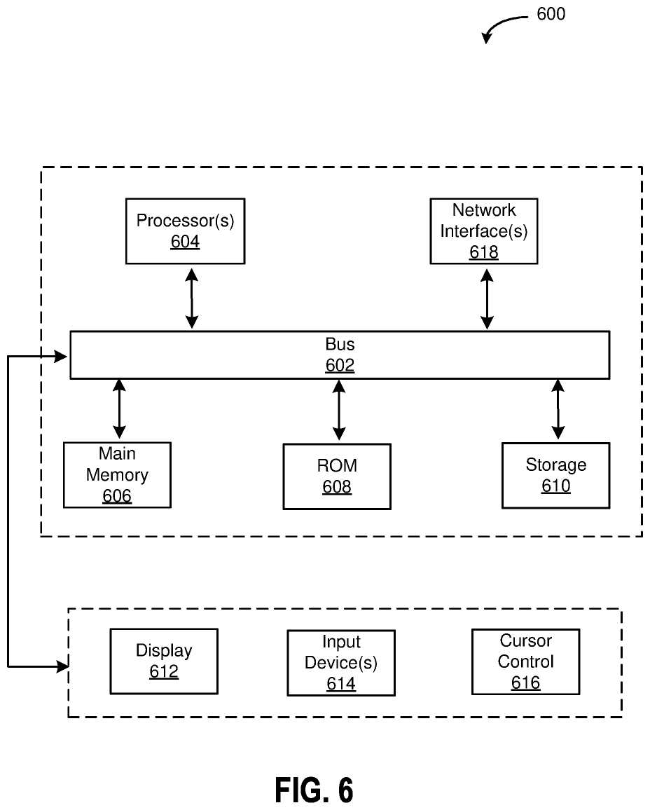

FIG. 6 depicts a block diagram of an example computer system 600 in which various of the embodiments described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some examples, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “application,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one example, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

What is claimed is:

1. A method of optimizing a serverless workflow, the method comprising:
receiving, at a first device, a directed acyclic graph (“DAG”) and a gamma tuning factor, wherein:
the DAG defines a first function within the serverless workflow, a second function within the serverless workflow, and an output-input relation between the first function and the second function; and
the gamma tuning factor defines a relative preference between cost and performance for the serverless workflow's execution;
collecting a first set of metrics regarding hardware on a network comprising a first node and a second node;
calculating cost and performance values for each possible configuration of a first stage comprising the first function based on the first set of metrics;
determining a first optimal serverless workflow stage configuration for the first stage based on the calculated cost and performance values for each possible configuration of the first stage, wherein the calculated cost and performance values are weighted according to the gamma tuning factor;
transmitting the first function to the first node, wherein the first node was designated for execution of the first function by the first optimal serverless workflow stage configuration; and
transmitting instructions detailing how an item of data output by the first function is to be stored among storage media available at the first node.

2. The method of claim 1, the method further comprising, after execution of the first function is completed:
collecting a second set of metrics regarding hardware on the network;
calculating cost and performance values for each possible configuration of a second stage comprising the second function based on the second set of metrics;
determining a second optimal serverless workflow stage configuration for the second stage based on the calculated cost and performance values for each possible configuration of the second stage, wherein the calculated cost and performance values are weighted according to the gamma tuning factor;
transmitting the second function to the second node, wherein the second node was designated for execution of the second function by the second optimal serverless workflow stage configuration; and
transmitting instructions detailing how an item of data output by the second function is to be stored among the storage media available at the second node.

3. The method of claim 1, further wherein a configuration of a stage is possible at least for each arrangement of functions comprising the stage among each node available on the network, and, for each arrangement of functions, further for each arrangement of outputs among the storage media available at each node executing the outputting function.

4. The method of claim 1, further wherein a configuration of a stage is constrained to configurations wherein outputs from a function are stored only at storage media available at the node executing the function.

5. The method of claim 1, further wherein a configuration of a stage is constrained to configurations wherein outputs from a function are stored only once among all storage media available.

6. The method of claim 1, further wherein a configuration of a stage is constrained to configurations wherein total data output by all functions executing at a node is less than or equal to storage capacity available at the node.

7. The method of claim 1, further wherein a configuration of a stage is constrained to configurations wherein processing resources needed by all functions executing at a node is less than or equal to the processing resources available at the node.

8. The method of claim 1, further wherein a configuration of a stage is constrained to configurations wherein volatile memory resources needed by all functions executing at a node are less than or equal to the volatile memory resources available at the node.

9. The method of claim 1, further wherein a configuration of a stage is constrained to configurations wherein the number of concurrent write operations carried out by all functions writing to a storage medium is less than or equal to the concurrent write limitations of the storage medium.

10. The method of claim 1, further wherein a configuration of a stage is constrained to configurations wherein the number of concurrent read operations carried out by all functions reading from a storage medium is less than or equal to the concurrent read limitations of the storage medium.

11. The method of claim 1, further wherein a configuration of a stage is constrained to configurations wherein data transfer resources needed by all functions reading data from a remote node are less than or equal the data transfer resources available on the network.

12. The method of claim 1, further wherein determining a first optimal serverless workflow stage configuration comprises solving Minimize {γΣᵢ[rᵢ+pᵢ+Σ_{d}Σ_{k′}x_{i,d}^{k′}(w_{i,d}^{k′}+Σ_{s,k}t_{i,sd}^{k})]+(1−γ)[Σ_{i,sd,k′}q_{i,d}^{k′}x_{i,d}^{k′}+c(Tᵢ)]}.

13. The method of claim 12, further wherein optimization factor x is calculated at a granularity corresponding to values of 0, 0.1, 0.2, . . . 1.

14. The method of claim 12, further wherein optimization factor x is calculated at a granularity corresponding to values of 0, 0.01, 0.02, . . . 1.

15. A system facilitating greater flexibility in optimizing a serverless workflow, the system comprising:
a node comprising a first storage media and a second storage media, the first storage media being of a first storage media type, and the second storage media being of a second storage media type; and
a cloud-computing platform server comprising a processor and a machine readable media, the machine readable media containing instructions which when executed by the processor cause the processor to:
run a serverless platform enabling functions to store data to persistent volumes, wherein the persistent volumes are grouped according to the first storage media type and the second storage media type; and
in response to execution of a function at the node wherein the function stores data to a persistent volume grouped according to the first storage media type, utilize a container storage interface associated with the first storage media type to permit data transfer of an output of the function to the first storage media.

16. The system of claim 15, further wherein the first storage media type is a byte addressed storage media type and the second storage media type is a block addressed storage media type.

17. The system of claim 16, further wherein the first storage media type is persistent memory (PMEM).

18. The system of claim 17, further wherein the container storage interface is pmem-csi.

19. The system of claim 16, further wherein the function stores a first portion of the data to a persistent volume grouped according to the first storage media type, and stores a second portion of the data to a persistent volume grouped according to the second storage media type.

20. A method of optimizing a serverless workflow, the method comprising:
receiving, from a user, a directed acyclic graph (“DAG”) and a gamma tuning factor, wherein:
the DAG defines a first function within the serverless workflow, a second function within the serverless workflow, and an output-input relation between the first function and the second function; and
the gamma tuning factor defines a relative preference between cost and performance for the serverless workflow's execution;
collecting a first set of metrics regarding hardware on a network comprising a first node and a second node;
calculating cost and performance values for each possible configuration of a first stage comprising the first function based on the first set of metrics;
determining a first optimal serverless workflow stage configuration for the first stage based on the calculated cost and performance values for each possible configuration of the first stage, wherein the calculated cost and performance values are weighted according to the gamma tuning factor;
transmitting the first function to the first node, wherein the first node was designated for execution of the first function by the optimal serverless workflow stage configuration; and
transmitting instructions detailing how an item of data output by the first function is to be stored among storage media available at the first node, the instructions resulting in partial storage of the item of data at a byte addressed storage media and partial storage of the item of data at a block addressed storage media.
